(19) United States
(12) Patent Application Publication
(10) Pub. No.: US 2024/0286848 A1
(43) Pub. Date: Aug. 29, 2024

(54) Industrial Systems, Methods and Devices for Handling and Managing Reusable Containers

(71) Applicant: RE:DISH CO., Washington, CT (US)

(72) Inventors: Thomas McCarthy, Babylon, NY (US); Caroline Vanderlip, New York, NY (US)

(21) Appl. No.: 18/444,669

(22) Filed: Feb. 17, 2024

Related U.S. Application Data
(60) Provisional application No. 63/448,999, filed on Feb. 28, 2023.

(51) Int. Cl. B65G 43/08; B08B 1/12; B08B 1/32; B08B 1/52; B08B 3/02; B65G 45/18; B65G 45/22; B65G 47/06; B65G 47/82; G06K 7/10; G06K 7/14

(52) U.S. Cl. CPC B65G 43/08; B08B 1/12; B08B 1/32; B08B 1/52; B08B 3/022; B65G 45/18; B65G 45/22; B65G 47/82; G06K 7/10366; G06K 7/1413; G06K 7/1417; B65G 47/06; B65G 2203/0216

(57) ABSTRACT

New systems, methods and devices for the management of reusable food containers, such as dishes and/or trays, are provided. Systems and devices for managing a large inventory of dishes or trays to be re-used, are provided. A re-usable tray management and processor device is provided. The re-usable tray management and processor device includes a control system, a first, tray-receiving end, a tray conveyor, at least one scanning device(s), a denester/dispenser, a separator and an offloading end, configured to offload soiled reusable food containers to a washing, drying and packing section. Rotary release actuator(s) are included within the denester/dispenser. And a new form of rotary actuator and brush and excavator tool is provided, coupled with each of the rotary release actuators. In some embodiments, the control system plans actions downstream of a pre-cleaning station, based on data received from the scanning device(s).

### CROSS-REFERENCE TO RELATED APPLICATION

This application claims the benefit of U.S. Provisional Application No. 63/448,999 filed Feb. 28, 2023, the entire contents of which are hereby incorporated by reference herein into the present application.

### INTELLECTUAL PROPERTY NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Unless otherwise stated, all trademarks and trade dress disclosed in this patent document and other distinctive names, emblems, and designs associated with product or service descriptions, are subject to trademark rights. The trademark and trade dress owner also reserves all trademark rights whatsoever.

### FIELD OF THE INVENTION

The present disclosures relate to handling and managing reusable food containers by industrial devices and systems. More specifically, some of the present disclosures relate to inventory management, servicing, fault detection and remediation in dishes and trays for the container reuse industry.

### BACKGROUND

Before the Industrial Revolution, product manufacturing, for the most part, was accomplished manually. Complex products were crafted with the aid of simple hand-driven tools and processes, by dedicated craftsmen. Starting in about the year 1750, a wide variety of machines powered by new energy sources, other than human effort, began to be integrated into product manufacturing (“powered production machines”). The use of such powered production machines has increased production efficiency and reduced production bottlenecks, leading to an acceleration of industrial growth, no longer as limited to population growth.

This integration of powered production machines into industrial production was perhaps most dramatic with the advent of the assembly line (a.k.a., “Progressive Assembly”), a manufacturing approach popularized and greatly improved by Ford Motor Company in the early 1900's. Assembly Lines involve moving an unfinished product through a series of work stations, where discrete assembly or other procedures take place, until a finished product is produced. Typically, powered production machines, as discussed above, are brought to bear in an assembly line, at least at some such work stations, although humans remain vital in many complex assembly line processes to this day. Depending on the product being produced, some assembly lines allow for the simultaneous production of different components of a product from smaller parts at work stations, followed by final assembly steps, combining all of the finished components, greatly reducing the time needed to produce a product. Rather than requiring the time for each production step, seriatim, as in traditional manufacturing, assembly lines are only time limited by the longest single step (a.k.a., the “bottleneck”).

Assembly lines also typically use standardized parts in assembly, meaning that a part integrated at a work station in a particular step is of a standard material, shape, size, weight and/or other characteristics. Each standardized part is thus essentially interchangeable with any number of similar standardized parts of its kind. Standardized parts are typically mass produced, also by machines, albeit typically in a separate, specialized production process. Standardized parts further reduce the need for sorting, handcrafting and manual manipulation, and yield more reliable results with each product produced by the assembly line being predictably similar.

Production labor is also standardized and specialized in assembly lines. Each assembly line worker may specialize in a particular step, becoming especially proficient in that step, increasing their collective productivity in comparison to each worker attempting to master all steps and switching between them. However, in some modern production lines, some such switching has been re-introduced recently, in order to reduce adverse sociological and health issues, such as mental illness and repetitive stress injuries, meaning injuries caused by the same task being repeated too frequently and for too long a time.

More recently, industrial robots have been integrated into some advanced production lines. Like humans, in some respects, industrial robots can be made to carry out a variety of different, changeable and complex assembly tasks. Whereas a human worker may be trained in a particular assembly task, robots may be programmed via computer software to do so. Generally speaking, the more variable and unpredictable the conditions of an assembly task, the better suited it is to a human worker, rather than an industrial robot. And the most defined, repetitive and fatiguing assembly tasks are best suited to industrial robots. Perhaps not coincidentally, a division of labor according to these different strengths aids tremendously in alleviating the sociological and health issues, discussed above.

However, even today, as beneficial as powered production machines and robotics have become, many complex products still require and benefit from hand assembly, individualized craftsmanship and other hallmarks of human labor, at least at some stages of production, to achieve the most desirable results. This causes production constraints. At the same time, the manufacturing and assembly of many products remains extremely dangerous for the human laborers.

There remains a strong and long-felt need for better production machines, robotics and processes.

It should be understood that the disclosures in this application related to the background of the invention, in, but not limited to this section titled “Background,” do not necessarily set forth prior art or other known aspects exclusively, and may instead include art that was invented concurrently or after the present invention and conception, and details of the inventor's own discoveries and work and work results.

### SUMMARY OF THE INVENTION

New systems, methods and devices for the management of reusable food containers, such as dishes and/or trays, are provided. Systems and devices for managing a large inventory of dishes or trays to be re-used, are provided. In some embodiments, a re-usable tray management and processor device is provided. In some embodiments, the re-usable tray management and processor device includes a control system, a first, tray-receiving end, a tray conveyor, at least one scanning device(s), a denester/dispenser, a separator and an offloading end, configured to offload soiled reusable food containers to a washing, drying and packing section. In some such embodiments, such systems and devices are configured for managing a plurality of specialized food trays, such as a new, special form of clamshell food tray.

In some such embodiments, the dish—and/or tray receiving end includes a food container denester and dispenser sub-device, which may include a nested tray stack holding and deployment feeder, and, in some such embodiments, the nested tray stack holding and deployment feeder is at least partially gravity-fed and/or gravity driven, including release ports, through which denested trays held in the feeder are dropped onto a conveyer. In some such embodiments, such release ports are located at, about and/or abutting a bottom of the food container denester and dispenser sub-device and/or the nested tray stack and deployment feeder. In some such embodiments, such tray-releasing actuators include one or more rotary release actuator(s), meaning rotating actuator(s), such as one or more screw (e.g., timing screw) actuator(s). In some such embodiments, such a separator is also at least partially gravity-driven, and, in some embodiments, includes a plurality of tray-removing actuators configured to remove particular food containers from a conveyor. For example, in some embodiments, a separator including a compressed air release nozzle and valve, actuable by a control system of the reusable food container management and processor device, is provided.

However, in some embodiments, another form of tray-releasing or other tray-handling actuator(s) may also, or alternatively, be included in the reusable food container management and processor device. For example, in some such embodiments, one or more vacuum pick-and-place actuator(s) may be so included.

In some such embodiments, the offloading end includes a modular, variable connection device, including connector hardware configured for interfacing with connector hardware of any of a wide variety of additional processing devices. In some such embodiments, a series of such additional processing devices, along with the reusable tray management and processor device, may be mutually configured to create a production and/or production line for servicing and producing cleaned reusable food containers. For example, in some embodiments, a food container washing device may be included as one such additional processing device. As another example, in some embodiments, a food container drying device may be included as one such additional processing device. As another example, in some embodiments, a food container sterilizing and/or antimicrobial device may be included as one such additional processing device. As another example, in some embodiments, a food container coating or other treating device may be included as one such additional processing device.

As another example, in some embodiments, a food container wrapping and/or packaging device may be included as one such additional processing device. In some embodiments, any of the containers, packaging, compartment(s) and/or sub-compartment(s) set forth above may be tamper-evident or otherwise may indicate whether they have been opened and/or the component(s) within them have been accessed and/or used. Such tamper-evident or other access or use indicating containers, packaging, compartment(s) and/or sub-compartment(s) are referred to as “use-evident” in the present application.

As mentioned above, rotary release actuator(s) are included within the denester/dispenser. And a new form of rotary actuator and brush and excavator tool is provided, coupled with each of the rotary release actuators.

In some embodiments, the control system plans actions downstream of a pre-cleaning station, based on data received from the scanning device(s).

### Canons of Construction

Where any term is set forth in a sentence, clause or statement (“statement”) in this application, each possible meaning, significance and/or sense of any term used in this application should be read as if separately, conjunctively and/or alternatively set forth in additional statement(s), after the sentence, clause or statement, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions.

These and other aspects of the invention will be made clearer below, in other parts of this application. This Summary, the Abstract, and other parts of the application, are for ease of understanding only, and no part of this application should be read to limit the scope of the invention, whether or not it references matter also set forth in any other part.

### BRIEF DESCRIPTION OF THE DRAWINGS

The features and advantages of example embodiments of the invention presented herein will become more apparent from the detailed description set forth below when taken in conjunction with the following drawings.

FIG. 1 is a perspective drawing of an example system for managing and processing reusable food containers, in accordance with some embodiments of the present application.

FIG. 2 is a schematic block diagram of some elements of a control system in accordance with some example embodiments.

FIG. 3 is an example process flow diagram, illustrating some example steps that may be carried out by a control system including specialized computer hardware and software (such as any of the control systems set forth in reference to FIG. 2, above), of a system for managing and processing reusable food containers, in accordance with some embodiments of the present application.

FIG. 4 is a bottom perspective drawing of an example food container denester and dispenser, which may be similar to one of the denester and dispensers shown and discussed above, in reference to FIG. 1, above, in accordance with some embodiments of the present application.

FIG. 5 is a side perspective drawing of an example pre-cleaning station including an example system for managing and processing reusable food containers, in accordance with some embodiments of the present application.

FIG. 6 is another example process flow diagram, illustrating some example steps that may be carried out by a control system including specialized computer hardware and software (such as any of the control systems set forth in reference to FIG. 2, above), of a system for managing and processing reusable food containers, in accordance with some embodiments of the present application.

FIG. 7 is a perspective drawing of an alternative embodiment of an example food container denester and dispenser, which may be similar to one of the denester and dispensers shown and discussed above, in accordance with some embodiments of the present application.

FIG. 8 is a perspective drawing of an alternative embodiment of the example food container denester and dispenser of FIG. 7, with rotary release actuator gearing exposed and newly visible, in accordance with some embodiments.

FIG. 9 is a perspective view, from the underside of an example food container denester and dispenser, including an example rotary release actuator coupled with a new form of rotary actuator and brush and excavator tool, in accordance with some embodiments.

### DETAILED DESCRIPTION OF THE INVENTION

The features and advantages of example embodiments of the invention presented herein are directed to new forms of systems, methods and devices for processing and management of reusable food containers, which are now described herein. These and other aspects will become more apparent from the detailed description set forth below when taken in conjunction with the drawings. This description is not intended to limit the application to the embodiments presented herein, which are only examples of the virtually unlimited possible embodiments falling within the scope of the present application. In fact, after reading the following description, it will be apparent to one skilled in the relevant art(s) how to implement the following example embodiments in alternative embodiments, including any possible order, number or other arrangement of components and subcomponents (the following orders, components, subcomponents and/or relationships being non-limiting).

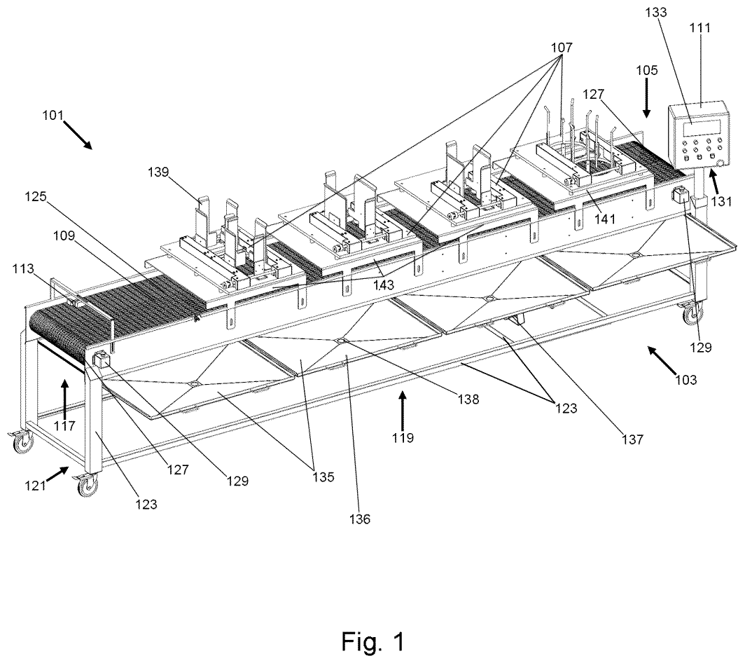

Embodiments of systems, methods and devices for processing and management of reusable food containers in accordance with some aspects set forth in this Specification are depicted in FIGS. 1 through 9. The following is a list of defined components and reference numbers therefor, as used throughout the figures:

| Reference | |
|---|---|
| No. | Component |
| 101 | system for managing and processing reusable food |
| | containers, dishes and/or trays |
| 103 | reusable dish and/or tray management and processor device |
| 105 | dish- and/or tray-receiving end |
| 107 | dish and/or tray denester(s)/dispenser(s) |
| 109 | dish and/or tray conveyor |
| 111 | local computer |
| 113 | scanning device |
| 115 | separator |
| 117 | offloading end |
| 119 | base |
| 121 | lattice |
| 123 | support beams |
| 125 | conveyor belt |
| 127 | conveyor drums |
| 129 | servomotors |
| 131 | local GUI |
| 133 | local display |
| 135 | lower shelves |
| 136 | sink |
| 137 | air compressor |
| 138 | lower drain |
| 139 | nested tray stack holding and deployment feeder |
| 141 | round food plate denester/dispenser |
| 143 | reusable clamshell food tray denesters/dispensers |
| 200 | control system |
| 201 | input/output device |
| 203 | memory device |
| 205 | long-term data storage device |
| 207 | processor(s) |
| 211 | local machine(s) |
| 213 | cameras and/or microphones |
| 215 | Internet of things or other ubiquitous computing devices |
| 217 | Application Programming Interface |
| 219 | display device |
| 220 | smartphone |
| 300-327 | example steps |
| 401 | food container denester and dispenser |
| 403 | bottom (of food container denester and dispenser 401) |
| 405 | release ports |
| 407 | stack-holding alignment guide |
| 409 | rotary release actuators |
| 411 | central axel |
| 413 | asymmetric lower flange |
| 415 | larger flange side |
| 417 | smaller flange side |
| 419 | denester/dispenser activity function sensor |
| 500 | pre-cleaning station |
| 501 | system (for managing and processing reusable food |
| | containers) |
| 503 | reusable dish and/or tray management and processor device |
| 505 | conveyor |
| 507 | conveyor belt |
| 509 | clamshell food tray |
| 511 | upper surface |
| 513 | scanner and camera device |
| 515 | structural rig |
| 517 | framework (of trusses) |
| 519 | vertical trusses |
| 521 | horizontal truss |
| 523 | base (of reusable dish and/or tray management and processor |
| | device 503) |
| 525 | conductive wires |
| 600-641 | example steps |
| 701 | food container denester and dispenser (alternative |
| | embodiment) |
| 703 | release ports |
| 704 | nested tray stack holding and deployment feeder |
| 705 | rotary release actuators |
| 706 | stack-holding alignment guide |
| 707 | central axel (of rotary release actuator) |
| 709 | asymmetric lower flange |
| 711 | larger flange side |
| 712 | central axel (of rotary release actuator) |
| 713 | smaller flange side |
| 715 | removable gear housing |
| 717 | bottom (of denester and dispenser 701) |
| 719 | spiral threading |
| 805 | gearing |
| 807 | cam shafts |
| 901 | food container denester and dispenser (additional alternative |
| | embodiment) |
| 903 | rotary release actuator (alternative embodiment) |
| 905 | spiral threading (of rotary release actuator 903) |
| 907 | leading, tapered point and/or edge (of spiral threading 905) |
| 909 | rotary motion arrow |
| 911 | release port (alternative embodiment) |
| 913 | rotary actuator and brush and excavator tool |
| 915 | axel |
| 917 | brush portion(s) (of rotary actuator and brush and excavator |
| | tool) |
| 919 | scraper portion(s) (of rotary actuator and brush and excavator |
| | tool) |
| 921 | periodic blades and/or other edges |
| 923 | high-velocity pressure washer |
| 925 | underside (of food container denester and dispenser 901) |
| 927 | nozzle |
| 929 | exit port |

FIG. 1 is a perspective drawing of an example system 101 for managing and processing reusable food containers, dishes and/or trays, in accordance with some embodiments of the present application.

In some embodiments, system 101 includes several components for managing a large inventory of dishes and/or trays to be re-used. In some such embodiments, system 101 includes a reusable dish and/or tray management and processor device 103, which includes a first, dish—and/or tray-receiving end 105, one or more dish and/or tray denester(s)/dispenser(s) 107, a dish and/or tray conveyor 109, a local computer 111, at least one scanning device 113, at least one separator 115 and a second, offloading end 117. In some embodiments, dish and/or tray management and processor device 103 includes a base 119, which includes a lattice 121 of interconnected support beams, such as, but not limited to, the examples shown as support beams 123, in some embodiments.

In some embodiments, base 119 is connected to, and supports, all other components of the reusable dish and/or tray management and processor device 103, including, but not limited to, tray conveyor 109. In some embodiments, dish and/or tray conveyor 109 includes a conveyor belt 125, driven by two conveyor drums 127, which may be driven by separate electric motors and sensors (e.g., servomotors 129). In some embodiments, such electric motors and sensors (and/or servomotors 129) are powered by, and/or communicatively connected to local computer 111, which may drive and issue commands to them (e.g., to start or halt conveying, and/or increase or decrease the speed of conveyor belt 125). In some embodiments, conveyor belt 125 may be so commanded by local computer 111 in response to sensed stimulus from one or more sensors, such as any of the servomotors 129 and/or scanning device 113, which also may be powered by and/or communicatively connected with local computer 111, in some embodiments.

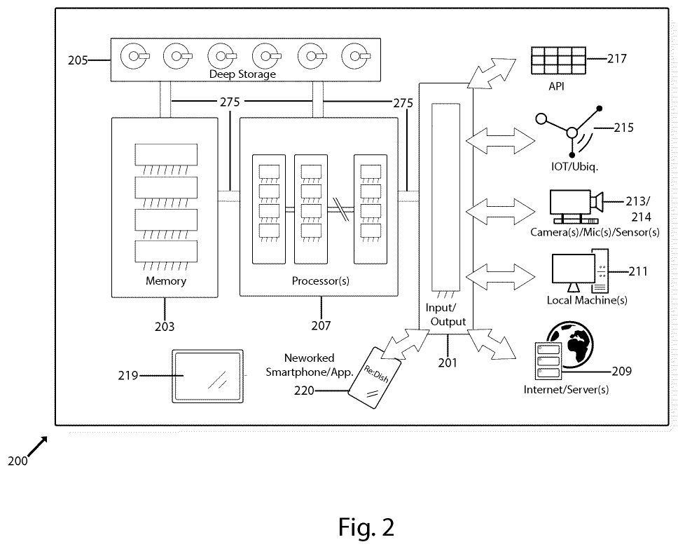

In some embodiments, local computer 111 may include, or be included within, a control system including computer hardware and software, such as the example control system provided in reference to FIG. 2, below. Thus, as discussed further below, in some embodiments, local computer 111 may be controlled by and/or communicatively connected with additional, remote control systems or computer hardware and software, over a wireless or other network (e.g., Wi-Fi or the Internet, in some such embodiments). In some such embodiments, such additional, remote control systems may include additional sensors and data (e.g., dynamic data, altered in real time), and such commands may be based on such data. For example, in some embodiments, such an additional, remote control system includes an Enterprise Resource Planning System (an “ERP”) with an inventory counting and/or tracking subsystem. In some such embodiments, individual reusable dishes and/or trays may be monitored and tracked (e.g., as they are stored and moved between facilities, e.g., manually, by human workers or by other devices and/or robotics, in various embodiments). However, in some embodiments, such a remote control system may not be included. In some such embodiments, a local GUI 131 may be included within local computer 111, including, in some such embodiments, a local display 133. In some such embodiments, local GUI 131 includes one or more user controls for a user (e.g., a human user, not pictured) to view output and provide input to local computer 111. In some embodiments, such a local computer is, or includes, a manufacturing controller, such as programmable logic controller (“PLC”). As with the remote control system embodiments discussed above, in some embodiments, such a manufacturing controller and/or PLC includes, and/or is communicatively connected with, an ERP that includes a dish and/or tray inventory counting and/or tracking subsystem, in some such embodiments.

In some embodiments, base 119 includes lower shelving, such as the example lower shelving shown as lower shelves 135, which, in some embodiments, may be positioned directly beneath tray conveyor 109 (as pictured). In some embodiments, each of lower shelves 135 is configured to collect debris falling from conveyer 109, and any soiled reusable trays or other dishes placed on conveyer 109. In some embodiments, each of lower shelves 135 includes a sink 136 and lower drain 138, which, in some such embodiments, may include a releasable valve for emptying debris and/or water or other cleaning fluids, from lower shelves 135. In some embodiments, base 119 carries additional sub-devices of reusable tray and/or dish management and processor device 103, such as example air compressor 137, which, in some embodiments powers separator 115, allowing re-usable tray and/or dish management and processor device 103 to remove and/or discard items as they are being conveyed by tray conveyor 109.

In some embodiments, each of the tray denester(s)/dispenser(s) 107 are provided at or about the tray receiving end 105 of reusable tray and/or dish management and processor device 103, and may be commanded by local computer 111 to de-nest and drop one or more trays, seriatim, for example, from a nested tray stack holding and deployment feeder 139, after which time, dish and/or tray conveyor 109 conveys such tray(s) toward the offloading end 117 (or discards them, as discussed below). In some such embodiments, the nested tray stack holding and deployment feeder 139 is at least partially gravity-fed and/or gravity driven. In some such embodiments, such a separator is at least partially gravity-driven, and includes a plurality of tray-releasing actuators located at, about and/or abutting a bottom of the nested tray stack and deployment feeder. In some such embodiments, such tray-releasing actuators include one or more rotating actuator(s), such as one or more screw (e.g., timing screw) actuator(s).

In some embodiments, scanning device 113 includes a camera, with a lens and sensor oriented to image objects (e.g., create an image file and/or save imaging data) as the food containers (e.g., dishes or trays) are being so conveyed by dish and/or tray conveyor 109. In some embodiments, local computer 111 includes software including image processing and analytical software which is configured to detect flaws in the surface and/or structure of any tray or other food container being conveyed on dish and/or tray conveyor 109 and, by comparing image data from scanning device 113 to expected image data (e.g., in an image library), may determine that such flaws exist, and activate separator 115 to remove such a tray or other food container from reusable tray and/or dish management and processor device 103 (e.g., by blowing it off of the top of dish and/or tray conveyor 109, e.g., into a defective tray receiving bin (not pictured)). In some embodiments, such a flaw detected by the sensor and control system may be a physical defect of the food container scanned and/or imaged (such as a scratch, dent, breakage or staining of a material of the food container. In some embodiments, such a flaw may be detected soil or other materials, such as food particles and debris, on the food container. In some embodiments, a fluid-dispensing nozzle or other cleaning device may be included on or about conveyor 109, and may be commanded by the control system to immediately target and clean such detected soil or other materials, removing it (or largely removing it). In some embodiments, such a flaw may be in a code or label attached to the food container. For example, in some such embodiments, such code or label attached to the food container may indicate the number of wash and/or use cycles endured by the food container being so scanned (e.g., by an outer piece or coded part of the label which erodes in the presence of a solvent used in a wash cycle, in some embodiments). Thus, in some such embodiments, the control system may determine that the number of washes that the food container has undergone exceeds a pre-set maximum number of wash cycles. If so, the control system may eject such a food container (e.g., via an air-driven separator), as it is scanned, and the control system may reduce the count of food containers in a set or run, for a particular customer for which the food containers will be delivered for another use cycle to contain food, and also reduce a resulting invoice for a monetary invoice to that customer, by an owner of the control system, and system 101, who may be a vendor servicing such food containers for such a customer.

In some embodiments, as pictured, multiple tray denester(s)/dispenser(s) 107 are provided at or about the tray receiving end 105, for managing and processing reusable food containers. In some such embodiments, some or each of such multiple denester(s)/dispensers are specialized for handling a particular type of tray, dish and/or other reusable food container having a particular size, weight and/or weight. In some such embodiments, the control system may denest and dispense only one such particular type of tray, dish and/or other reusable food container at a time (e.g., by commanding only one such dispenser at a time). For example, as pictured, example round food plate denester/dispenser 141, shown as the furthest dispenser to the right-hand side of the figure, is configured to dispense reusable round food plates of a particular diameter (e.g., 6-inches, 7 inches, 8 inches, 9 inches, 10 inches, or 11 inches, etc.) As another example, as pictured, example reusable clamshell food tray denesters/dispensers 143 each may denest and dispense a particular type of reusable clamshell food tray, when so commanded by the control system comprised within, or comprising, system 101. In some embodiments, at least some of clamshell food tray denesters/dispensers 143 each denest and dispense a different type of such a reusable clamshell food tray. However, in some embodiments, at least some of clamshell food tray denesters/dispensers 143 denest and dispense the same type of such of reusable clamshell food tray and, in some such embodiments, may so denest and dispense individual reusable clamshell food trays in the same deployment of a set of such clamshell food trays (e.g., to a different area of conveyor 109 or in a coordinated placement pattern, avoiding the placement of multiple such clamshell food trays at the same location on conveyor 109.)

In some embodiments, as discussed in greater detail below, the denesting and dispensing of food containers by de-nester(s)/dispenser(s) 107 may be monitored, and successful or unsuccessful denesting and dispensing may lead to other, remedial actions by a control system of example system 101. In some embodiments, such separate monitoring may be carried out by dedicated, separate camera(s) or other sensor(s), other than the scanning device 113.

FIG. 2 is a schematic block diagram of some elements of an example control system 200 (herein, a “control system”), including computer hardware and software, in accordance with some example embodiments of the present invention. In some example embodiments, the control system incorporates a non-transitory machine-readable medium storing instructions that, when executed by one or more processors, execute various aspects of the present invention described herein. The generic and other components and aspects described herein are not exhaustive of the many different systems and variations, including a number of possible hardware aspects that might be used, in accordance with the example embodiments of the invention. Rather, the control system 200 shown depicts some example embodiments.

Control system 200 includes an input/output device 201, a memory device 203, long-term data storage device 205, and processor(s) 207, in some embodiments. The processor(s) 207 is (are) capable of receiving, interpreting, processing and manipulating signals and executing instructions for further processing and for output, pre-output and/or storage in and outside of the control system 200. The processor(s) 207 may be general or multipurpose, single—or multi-threaded, and may have a single core or several processor cores, including microprocessors. Among other things, the processor(s) 207 is/are capable of processing signals and instructions for the input/output device 201, to cause a user interface to be provided or modified for use by a user on hardware, such as, but not limited to, computer system peripheral devices, such as a mouse, keyboard, touchscreen and/or display device 219, providing specialized tools (e.g., providing a graphical user interface, a.k.a. a “GUI,” providing any of the GUI tools discussed in the present application related to providing alerts and notices to, and accepting operating commands from, users of a reusable food containers, dishes and/or trays management, cleaning, preparation, storage and/or shipping system.) In some embodiments, such signals and instructions are based on display-controlling and input-facilitating software (e.g., on local machine(s) 211, mouse, keyboard, touchscreen and/or display device 219 or smartphone 220).

For example, user interface aspects, such as graphical “windows,” “buttons” and data entry fields, may present via, for example, a display, any number of selectable options and/or data entry fields. When such an option and/or data entry field is selected and/or data is entered by a user, such selection and/or data entry causes aspects of the control system to command other aspects of the control system to present additional instructions, GUI tools or other guidance to a user related to managing the cleaning, preparation, storage and shipping of reusable food containers, dishes and/or trays (e.g., for the food service industry). In some embodiments, such selection and/or data entry causes aspects of the control system to begin a denesting, conveyance and cleaning regimen, followed by a drying, treatment and packing and shipping routine. For example, and as explained in greater detail elsewhere in this application, the control system may command an off-loader (not pictured) to offload dusted, debrided and/or treated reusable food containers, dishes and/or trays to offload such food containers to a secondary device or sub-component for cleaning, disinfecting, drying and/or packing such reusable food containers. The processor(s) 207 may execute instructions stored in memory device 203 and/or long-term data storage device 205, and may communicate via system bus(ses) 275. Input/output device 201 is capable of input/output operations for the system, and may include and communicate through input and/or output hardware, and instances thereof, such as a computer mouse, scanning device or other sensors, actuator(s), communications antenna(ac), keyboard(s), smartphone(s) and/or PDA(s), networked or connected additional computer(s), camera(s) or microphone(s), a mixing board(s), real-to-real tape recorder(s), external hard disk recorder(s), additional movie and/or sound editing system(s) or gear, speaker(s), external filter(s), amp(s), preamp(s), equalizer(s), computer display screen(s) or touch screen(s). Such input/output hardware could implement a program or user interface created, in part, by software, permitting the control system and user to carry out the user settings and input discussed in this application. Input/output device 201, memory device 203, data storage device 205, and processor(s) 207 are connected and able to send and receive communications, transmissions and instructions via system bus(ses) 275. Data storage device 205 is capable of providing mass storage for the system, in some embodiments, and may be or incorporate a computer-readable medium, may be a connected mass storage device (e.g., flash drive or other drive connected to a Universal Serial Bus (USB) port or wireless connection, such as Wi-Fi), may use back-end (with or without middle-ware) or cloud storage over a network (e.g., the Internet) as either a memory backup for an internal mass storage device or as a primary memory storage means, or may simply be an internal mass storage device, such as a computer hard drive or optical drive. Generally speaking, the control system may be implemented as a client/server arrangement, where aspects of the system are performed on a remote server, networked to the client and made a client and server by software on both the client computer and server computer. In any event, the system may include, or include network connections (e.g, wired, WAN, LAN, 5G, ethernet, satellite, and/or Internet connections) with any of the example devices or auxiliary devices and/or systems, shown as Internet server(s) 209, local machine(s) 211, cameras and/or microphones 213, sensor(s) 214, Internet of things or other ubiquitous computing devices 215, Application Programming Interface 217 (herein, “API”), mouse, keyboard, touchscreen and/or display device 219 and/or smartphone 220. Similarly, the control system 200 is capable of accepting input from any of those auxiliary devices and systems, and modifying stored data within them and within itself, based on any input or output sent through input/output device 201.

Input and output devices may deliver their input and receive output by any known means, including, but not limited to, any of the hardware and/or software examples shown as Internet server(s) 209, local machine(s) 211, cameras and/or microphones 213, sensor(s) 214, Internet of things or other ubiquitous computing devices 215, API 217, mouse, keyboard, touchscreen and/or display device 219 and smartphone 220.

While the illustrated example of a control system 200 in accordance with the present invention may be helpful to understand the implementation of aspects of the invention, any suitable form of computer system known in the art may be used—for example, in some embodiments, a simpler computer system containing just a processor for executing instructions from a memory or transmission source. The aspects or features set forth may be implemented with, and in any combination of, digital electronic circuitry, hardware, software, firmware, middleware or any other computing technology known in the art, any of which may be aided with external data from external hardware and software, optionally, by networked connection, such as by LAN, WAN, satellite communications networks, 5G or other cellular networks, and/or any of the many connections forming the Internet. The system can be embodied in a tangibly-stored computer program, as by a machine-readable medium and propagated signal, for execution by a programmable processor. The many possible method steps of the example embodiments presented herein may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

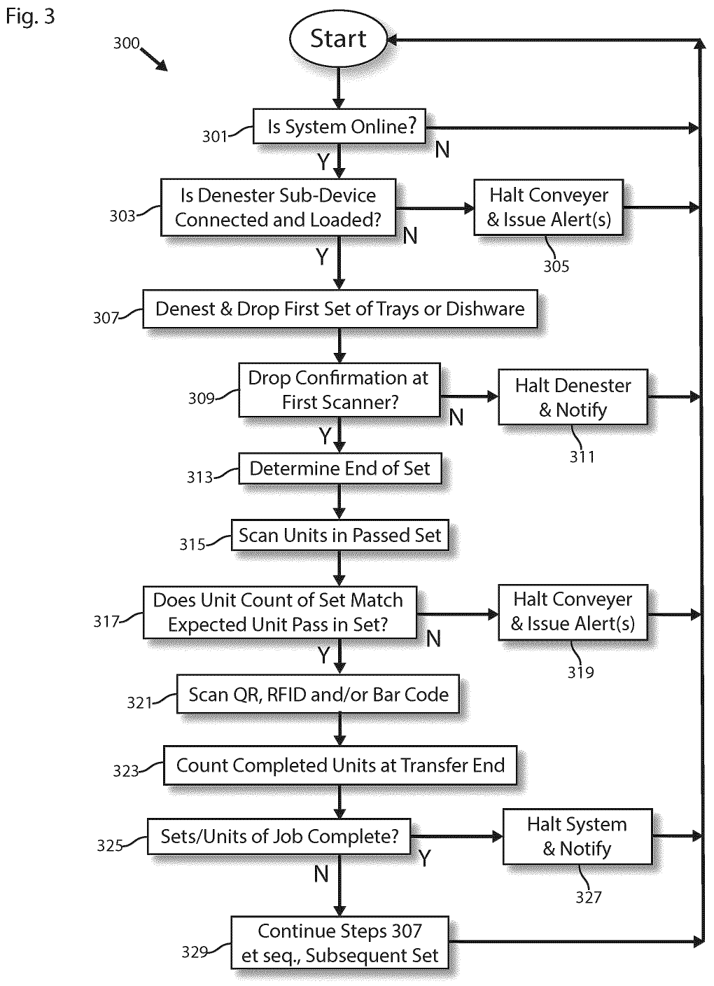

FIG. 3 is an example process flow diagram, illustrating some example steps 300 that may be carried out by a control system including specialized computer hardware and software (such as any of the control systems set forth in reference to FIG. 2, above), of a system for managing and processing reusable food containers, in accordance with some embodiments of the present application. As discussed elsewhere in this application, in some embodiments, such a control system may include, or be included within, a local computer and/or PLC, such as the example local computer 111 discussed above.

Beginning with step 301, in some embodiments, the control system begins by first determining whether all required software modules and networks for running the system for managing and processing reusable food containers and/or dishware are available (e.g., on-line and active, with no reported functional errors, in some embodiments). If so, the control system proceeds to subsequent step 303, in which it communicates with one or more de-nester(s) or other reusable food container dispenser(s) (such as example de-nester(s)/dispenser(s) 107, discussed above) to determine whether it/they are ready to denest/dispense food containers, meaning that the dispenser(s) are each activated, properly connected for communications with the control system, properly installed onto a reusable tray and/or dish management and processor device, such as example re-usable tray and/or dish management and processor device 103 (e.g., by position and mounting sensors (not pictured)) and/or loaded with one or more reusable tray(s) and or (dish(es)). If not, the control system may proceed to step 305, in which it halts moving machinery of the system for managing and processing reusable food containers (e.g., conveyer 109, discussed above) and/or issues one or more alert(s) to users of the control system, that the system for managing and processing reusable food containers is not ready and such moving machinery has been halted (e.g., via display, such as example local display 133, and/or an audible siren, claxon and/or speaker), and the control system may then return to the starting position, in some embodiments. But, if the control system determines, at step 303, that the dispenser(s) are ready to denest/dispense food containers, the control system proceeds to step 307. It should also be mentioned that, if, at step 301, the control system determines that all required software modules and networks for running the system for managing and processing reusable food containers are not available, the control system may return to the starting position, in some embodiments.

In step 307, in some embodiments, the control system next may issue a command to the dispenser(s) to denest and release, e.g., onto conveyor 109, a set of reusable trays, dishes and/or other food containers, in some embodiments. In some embodiments, such a set of reusable trays, dishes and/or other food containers is a set of reusable trays. In some embodiments, such a set of reusable trays, dishes and/or other food containers is a set of reusable dishes. In some embodiments, such a set of reusable trays, dishes and/or other food containers is a set of reusable food containers. In some embodiments, such a set of reusable trays, dishes and/or other food containers includes used and/or soiled reusable trays, dishes and/or other food containers. As discussed above, in some embodiments, as discussed above, multiple dispensers are included within the system for managing and processing reusable food containers. In some such embodiments, some or each of such multiple dispensers are specialized for handling a particular type of tray, dish and/or other reusable food container having a particular size, weight and/or weight. In some such embodiments, the control system may denest and dispense only one such particular type of tray, dish and/or other reusable food container at a time (e.g., by commanding only one such dispenser at a time).

Next, in step 309, the control system may proceed to receive data from a camera, scanner and/or other sensor located on or about the one or more activated dispenser(s) that has been commanded to so denest and dispense food containers, and determines whether such denesting and dispensing is properly dropping such food containers onto the conveyor, in a proper position and/or orientation, without malfunction and/or at the location(s) planned by the control system. If the control system determines that such denesting and dispensing is not properly dropping or releasing such food containers, in a proper, pre-planned position and orientation and/or the dispenser has otherwise malfunctioned, the control system may proceed to step 311, in which it halts moving machinery of the system for managing and processing reusable food containers (e.g., conveyer 109) and/or issues one or more notification(s) and/or alert(s) to users of the control system (e.g., maintenance staff), that the system for managing and processing reusable food containers has malfunctioned and such moving machinery has been halted (e.g., via display, such as example local display 133), and the control system may then return to the starting position, in some embodiments. If, however, the control system determines that such denesting and dispensing is so properly dropping such food containers, the control system may proceed to step 313, in which it determines (in some embodiments, based on the speed of dispensing and the speed of the conveyor and/or a number of feeders and/or exit ports) an estimated number of reusable food containers expected to be so denested and dispensed from the dispenser within a set or “run” of such food containers being so denested and dispensed (e.g., emptying an entire loaded set within a feeder of nested food containers held within the dispenser prior to such denesting and dispensing).

Next, in some embodiments, such a number of food containers may be compared to a count of scanned food containers then conveyed from the dispenser(s). For example, in example step 317, in some embodiments, such a count is made with the aid of a second camera, scanner and/or other sensor, located downstream, at a position closer to the conveyor and offloading end (such as example sensor 113, located on or about the offloading end 117 of example system 101), by which the denested and dispensed food containers then pass. In some embodiments, if the control system determines that such a count does not match the number of food containers stored for such a set or “run,” the control system proceeds to step 319, in which it halts moving machinery of the system for managing and processing reusable food containers and/or issues one or more notification(s) and/or alert(s) to users of the control system, that the system for managing and processing reusable food containers has malfunctioned and such moving machinery has been halted (e.g., via display, such as example local display 133), and the control system may then return to the starting position, in some embodiments.

In some embodiments, at or about the same time as aiding in such a count of passing food containers, the second camera, scanner and/or other sensor also may scan and record a unique code and/or tag present on or in each of the food containers, in step 321. In some embodiments, such a unique code may be, or may be included within, an QR code. In some embodiments, such a unique code may be, or may be included within, a bar code. In some embodiments, such a unique code may be, or may be included within, both a bar code and a QR code. In some embodiments, each of such food containers within a set or run may include a code or code part that is the same as, or has an identifying element in common with, a code for other food containers within the set or run. In some embodiments, such an identifying element is a QR code or part thereof, a bar code or part thereof, and/or an RFID tag. In some embodiments, such a code or code part is also, or alternatively, present on a larger container, in which all of the food containers within the set or run were, or will be, located. In some embodiments, such a container is scanned by a third scanner upon arrival or departure of the food containers within the set or run from a facility in which the system for managing and processing reusable food containers is located.

In some embodiments, if, with respect to any food container that is being scanned by the second camera, scanner and/or other sensor, any such codes are unreadable (e.g., because they are not detected or successfully scanned), the control system may command a separator (such as any of the separators discussed above) to remove (e.g., by blowing off the conveyor) any food container bearing such an unreadable code. In some embodiments, the control system may also command a separator (such as any of the separators discussed above) to remove (e.g., by blowing off the conveyor) any food container determined to be worn, overly soiled and/or broken (e.g., by camera inspection and comparison to data in a library of the control system related to unworn, intact food containers).

In some embodiments, after scanning at the second camera, scanner and/or other sensor, the control system next performs an additional count, based on the number of codes successfully scanned and recorded, in subsequent step 323. In some embodiments, such a final count is then recorded by the control system to determine a final number of food containers in the set or run to be cleaned, treated, disinfected and/or packed for a customer user. In some embodiments, a monetary charge and/or credit may be determined for such a customer user, based on such a final count.

In some embodiments, the control system determines, in step 325, if a set or run is complete, by adding the count to a separate count of all removed, and determines if the set or run has been completed. In some embodiments, if the control system determines that such a set or run is not completed, the control system proceeds to step 327, in which it halts moving machinery of the system for managing and processing reusable food containers and/or issues one or more notification(s) and/or alert(s) to users of the control system that an error has occurred in the final count and that such moving machinery has been halted (e.g., via display, such as example local display 133), and the control system may then return to the starting position, in some such embodiments. If however, no such error is determined to exist, the control system may repeat steps 303 et. seq. for any additional sets or runs of food containers remaining loaded in any dispenser of the system for managing and processing reusable food containers, before returning to the starting position.

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

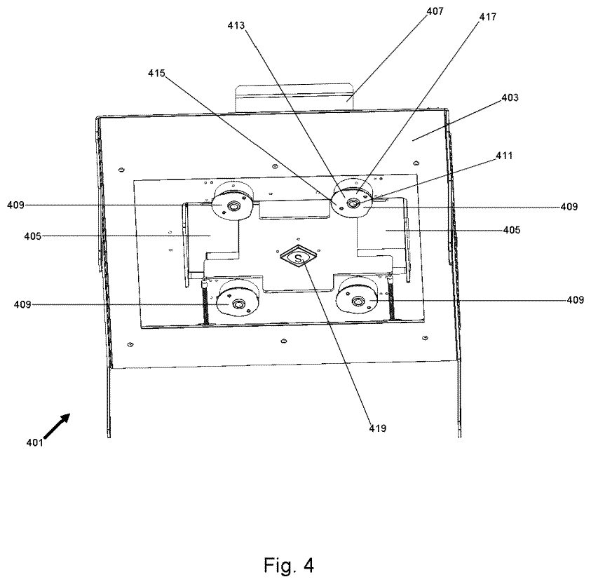

FIG. 4 is a bottom perspective drawing of an example food container denester and dispenser 401, which may be similar to one of the denester and dispensers shown and discussed above, in reference to FIG. 1, above, in accordance with some embodiments of the present application. More specifically, food container denester and dispenser 401 may be the same as, or similar in nature to, the left-most (in the perspective of FIG. 1) of the example denester and dispensers 107.

Because the perspective view in the present figure is from below the food container denester and dispenser 401 (i.e., from a position at or about lower shelves 135), a bottom 403 of food container denester and dispenser 401 is visible.

Generally speaking, denester and dispenser 401 is configured to hold and dispense individual clamshell trays from two vertical stacks of generally square-profile clamshell trays (not pictured) through two example release ports 405, and onto a conveyer, such as example conveyer 109, discussed above, in some embodiments. Such clamshell food containers and other food containers (e.g., dishes and other trays) may have outer edges, in some embodiments, and, when nested, will have those edges generally aligned vertically (aligned along an axis perpendicular to bottom 403, and passing from the bottom 403 to the top the food container denester and dispenser 401), in such a vertical stack. Each of release ports 405 may have a shape complementary to, but slightly larger than, the shape of the perimeter of such aligned edges, allowing trays in each stack to pass through the release ports 405, at least, when release actuators are commanded by computer 111 to release individual trays, as will be explained further below. In some embodiments, stack-holding alignment guides, such as example stack-holding alignment guide 407, may be provided, in some embodiments, aiding in guiding such trays in so passing through the release ports 405.

In various embodiments, a wide variety of possible release actuators may be provided, to aid in the controlled release of such individual food trays. For example, in some embodiments, as pictured, rotary release actuators, such as example rotary release actuators 409, are provided. As pictured, each of rotary release actuators 409 may rotate (e.g., by a rotary electric actuator, motor or servo-motor) about a central axel, such as the example central axel 411. In some embodiments, each of example rotary release actuators 409 includes an asymmetric lower flange, such as example asymmetric lower flange 413 (which are each generally, similar in shape to a cam) with one larger flange side 415 having a larger radius (measured from the center of axel 411) than another, smaller flange side 417. In some such embodiments, when facing inward, toward the respective release port 405 which it borders, larger flange side 415 prevents the passage downward (e.g., with gravity) of such a tray edge passing through that release port. In other words, when so facing inward, larger flange side 415 extends inward and beyond the width of that release port. Because each such rotary release actuator may rotate in unison, with each of their such larger flange sides facing inward simultaneously or outward simultaneously, e.g., by shared gearing, and at a speed that may be controlled by the computer 111, example rotary release actuators 409 may rotate in a coordinated fashion, to separate, denest and drop a single tray at a time. It should be noted that, although not visible in the present figure, such shared gearing may be disposed on an upper surface of the denester and dispenser 401, in some embodiments. As discussed elsewhere in this application, in some embodiments, local computer 111, or another PLC including or included within a control system, in accordance with some such embodiments, may include and/or be communicatively connected with one or more scanning apparatus(es) and/or sensor(s), including a sensor disposed on or about, or within line of site, of activity created by example food container denester and dispenser 401. In some embodiments, at least one such scanning apparatus or sensor may be disposed on or about bottom 403, such as the example sensor shown as denester/dispenser function sensor 419. In some embodiments, such a sensor may be, or may include, a motion sensor. In some embodiments, such a sensor may be, or may include, a camera. However, in some embodiments, such a sensor may be, or may include any other suitable sensor known in the art. In some such embodiments, such a motion sensor may be configured to sense motion of trays dropped or otherwise released moved through ports 405. In some embodiments, such a sensor may detect the presence of a food container, such as a tray, on a conveyor, position(s) below, or approximately below, ports 405. In some embodiments, such a sensor, in conjunction with object detection and orientation determining techniques, may determine whether food trays or other food containers have landed on such a conveyer in a planned or otherwise proper orientation (e.g., upright and/or with edges parallel to conveyer movement)—i.e., that the food containers have each been “properly dropped.” Thus, in some embodiments, such a computer and/or control system may determine whether trays or other food containers have been properly released or dropped. As discussed above, in some embodiments, such a computer and/or control system may halt the conveyer, and issue warning, alerts or other notices to users (e.g., through a speaker and/or display), if any such released or dropped containers are not properly dropped, as planned.

Although the example of release actuators with an asymmetric lower flange is provided, it will be understood by those of skill in the art that a wide variety of alternatives may be used, as an alternative, or in addition, to such release actuators. For example, in some embodiments, some or all of rotary release actuators 409 may include spiral threading, which interfaces with and separates an individual edge of such an individual food trays.

Also, although the example of a food tray denester and dispenser has been provided, it should be understood that any suitable alternative form of nested food container, including addressable outer edges, may be similarly denested and dispensed, in a similar fashion, though release port(s) of a different shape and size, instead complementary to such an alternative form of nested food container, in various embodiments.

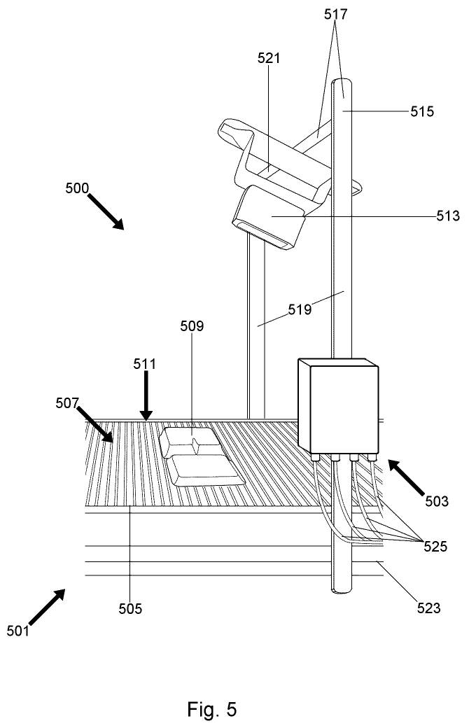

FIG. 5 is a side perspective drawing of an example pre-cleaning station 500 of an example system 501 for managing and processing reusable food containers, such as any of the systems for managing and processing reusable food containers set forth in the present application, in accordance with some embodiments. As with other systems for managing and processing reusable food containers set forth in the present application, the system 501 includes a reusable dish and/or tray management and processor device, such as example reusable dish and/or tray management and processor device 503, in some embodiments. And, as discussed above, such a reusable dish and/or tray management and processor device may include any of the components for such a device, as discussed elsewhere in this application.

Generally speaking, pre-cleaning station 500, and reusable dish and/or tray management and processor device 503 (of which it is a part) may include a portion of a conveyor 505, in some embodiments, which may be the same as, or similar in nature to, any of the conveyors set forth in the present application, and which may accommodate a conveyor belt 507, as with other such conveyors set forth in this application, upon which reusable food containers may be located, transported and processed. For example, one such reusable food container is provided as example clamshell food tray 509, shown in an opened, denested and face-down configuration, on an upper surface 511 of conveyor belt 507.

Generally speaking, in some embodiments, pre-cleaning station 500 may be located “downstream” from a first, dish—and/or tray-receiving end at or about which one or more soiled dish and/or tray denester(s)/dispenser(s) are located, placing soiled reusable dishes and/or trays onto upper surface 511 of conveyor belt 507. However, because the view of the reusable dish and/or tray management and processor device 503 in the present figure is partial, such soiled dish and/or tray denester(s)/dispenser(s) is/are not pictured in the present figure. But it should be understood that such soiled dish and/or tray denester(s)/dispenser(s) are located toward the right-hand side of the figure and pre-cleaning station 500 of the reusable dish and/or tray management and processor device 503 and, when reusable dish and/or tray management and processor device 503 is operational, upper surface 511 of conveyor belt 507, is moving, at least generally, from the right-hand side to the left-hand side, in the perspective of the figure. Thus, upper surface carries any reusable food containers (such as example clamshell food tray 509) dispensed onto upper surface 511 through pre-cleaning station 500, also from right to left. Such soiled dish and/or tray denester(s)/dispenser(s) may be the same as, or similar in nature to, any of the denester(s)/dispenser(s) set forth in the present application, such as example food container denester and dispenser 401, in some embodiments.

In some embodiments, pre-cleaning station 500 includes a scanning device, such as example scanner and camera device 513, which may be mounted on an example structural rig 515, in some such embodiments. In some embodiments, structural rig 515 includes a framework 517 of trusses, such as example vertical trusses 519 and example horizontal truss 521, which may be attached to a base 523 of reusable dish and/or tray management and processor device 503, in some embodiments. In some embodiments, example scanner and camera 513 is connected for communications and/or power to a control system including computer hardware and software (e.g, through example conductive wires 525). And, because scanner and camera device 513 is aimed at the upper surface 511 of conveyor belt 507, scanner and camera device 513 is in a position to scan and obtain images of any object placed on upper surface 511, as it is carried through example pre-cleaning station 500. Furthermore, as discussed in greater detail below, the control system may record such images and other information related to such an object, and carry out additional steps based on such information.

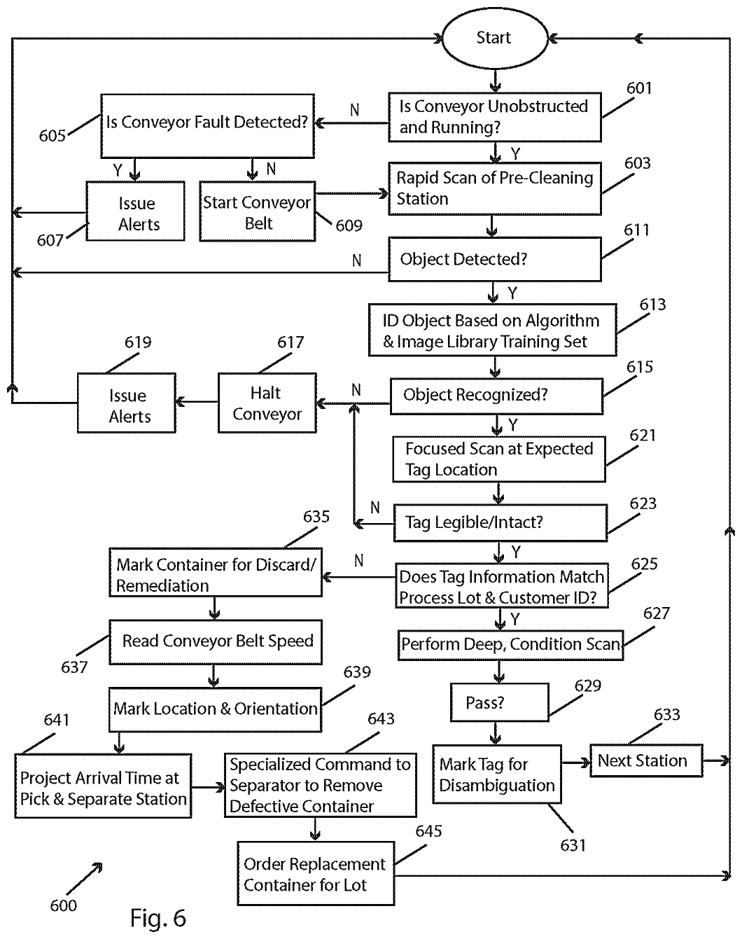

FIG. 6 is another example process flow diagram, illustrating some example steps 600 that may be carried out by a control system including specialized computer hardware and software (such as any of the control systems set forth in reference to FIG. 2, above), of a system for managing and processing reusable food containers in accordance with some embodiments of the present application. More specifically, example steps 600 relate to methods by which such a control system may execute operations of a reusable dish and/or tray management and processor device, with which it is communicatively connected, based on data gathered at or about a pre-cleaning station thereof, such as the example pre-cleaning station 500, discussed with respect to the immediately preceding figure. As discussed elsewhere in this application, in some embodiments, such a control system may include, or be included within, a local computer and/or PLC, such as the example local computer 111 discussed above. However, as also discussed above, in some embodiments, such a control system may include remote aspects, such as being at least partially implemented on server computer, remote from such a local computer, as a client/server arrangement, where aspects of the system are performed on a remote server, networked to the local computer, as a client/server arrangement (e.g., over a wireless network and/or the Internet). In this way, in some embodiments, an administrative user may be located a considerable distance away from the site of the local control system installed in or about a reusable dish and/or tray management and processor device, while still maintaining at least some control over the control system, in some such embodiments. In any event, regardless of the structure of all aspects of the control system, the control system may carry out the following example steps.

Beginning with step 601, in some embodiments, the control system begins by determining whether a conveyor of the system for managing and processing reusable food containers of which it is a part is activated and running, meaning that a conveyor belt of the conveyor is moving at an appropriate operational speed (e.g., to accommodate a rate at which soiled plates, dishes or containers are being denested onto it, as discussed above.) In some embodiments, the appropriate operational speed may be determined by the control system based on a range of possible appropriate speeds. And, in some embodiments, the control system may also determine whether an obstruction, e.g., within the conveyor drive mechanism or on or about the conveyor belt, or other condition, is inhibiting the expected operational speed of the conveyor as it is running. In some embodiments, the control system senses the actual speed of the conveyor belt, and compares it with the expected operational speed, to determine if they match and, if they do not, the control system further determines that the conveyor is unobstructed and running. If the conveyor is determined to be unobstructed and running, the control system next proceeds to step 603, in some embodiments, in which it activates a scanner and camera, such as example scanner and camera device 513, discussed above, is activated, meaning that it is receiving power, and powered on, and/or responsive to communications from control system, in some embodiments, and carries out scanning and/or imaging operations, as discussed further below. If, however, the control system determines that the conveyor is obstructed, or not running altogether, the control system may proceed to step 605, in which it instead may run diagnostic testing and troubleshooting (e.g., based on error messages arising from other cameras or sensors on or about the conveyor mechanism or conveyor belt). If the results of such testing and troubleshooting indicate that an obstruction is present and interfering with the otherwise expected and/or commanded operation of the conveyor, or that some other relevant fault has been detected, the control system may then proceed to step 607, in which it may issue alerts, such as a siren or light located on or about the reusable dish and/or tray management and processor device, to one or more users of the control system (such as an administrative user, or an assembly line technician, working adjacent to the conveyor). If, however, the control system determines, at step 605, that no such obstruction or other fault is in fact present, the control system proceeds to step 609, in some embodiments, in which the control system starts (or restarts) the conveyor, until it is unobstructed and running at the appropriate operational speed. Once the conveyor is unobstructed and running at the appropriate operational speed, the control system may proceed to step 603, in some embodiments, in which it activates a scanner and camera, such as example scanner and camera device 513, as discussed above. Once at step 603, the control system then performs a preliminary, rapid scan of an upper surface of the conveyor belt located within or about the pre-cleaning station.

Based on image or other data from the preliminary, rapid scan, the control system may next determine, e.g., based further on an object detection algorithm applied to the image or other data, whether an object has been detected on the upper surface of the conveyor belt located within or about the pre-cleaning station, in step 611. If not, in some embodiments, the control system may return to the starting position. If, however, the control system determines that an object has been detected on the upper surface of the conveyor belt located within or about the pre-cleaning station, the control system proceeds to step 613, in which it proceeds to perform a more detailed, intensive scan and/or take a higher resolution image (and/or, in some embodiments, group of images, from multiple times or perspectives) of the detected object, and attempts to identify the type of object located within or about the pre-cleaning station. For example, in some embodiments, the control system applies an object recognition algorithm to the data generated by the more detailed, intensive scan, or higher resolution image(s). And, in some embodiments, such an object recognition algorithm may be based, at least in part, based on a neural network based on a library of such data and/or images related to other objects located on or about the conveyor, or similar conveyors (e.g., on or about the same, or similar pre-cleaning station(s)). If the application of the object recognition algorithm indicates a likely match (e.g., above a pre-set probability and/or confidence interval) with a type of object, the control system may next determine that the object has been recognized as that object, and may label the object accordingly, in step 615. If not, however, the control system may proceed to step 617, in some embodiments, and halt the conveyor, and issue alerts to users in subsequent step 619, before returning to the starting position.

If the object has been recognized and labeled (e.g., within a database of the control system) as being of a particular known type of object, such as a type of plate, dish or container to be properly processed and managed by the control system, the control system may next perform a focused scan of a particular surface area of the particular plate, dish or container, which arca has been mapped as the location of an encoded, data-bearing tag placed on plate(s), dish(es) or container(s) of that same type, in step 621. Next, based on the focused scan the control system may next determine, in step 623, whether the tag is intact, and if complete data can be read from the focused scan of the surface of the tag. If not, the control system may proceed to steps 617 and 619, as discussed above, halt the conveyor, and issue alerts to users, before returning to the starting position.

If, however, complete data can be read from the focused scan of the surface of the tag, the control system proceeds to step 625, in some embodiments, in which it determines whether the tag indicates that the plate, dish or container detected matches an identified lot of soiled reusable plates, dishes or containers and/or belongs to a client of an owner of the control system. If the plate, dish or container is so identified, the control system proceeds to step 627, in some embodiments, in which it may command the scanner and camera to perform a more thorough, deeper scan of the physical condition of the (e.g., to detect deviations from expected proportions, shapes and clarity, e.g., indicating damage and/or excessive soil, which may be too great to remediate with washing components of the reusable dish and/or tray management and processor device, downstream from the pre-cleaning station).

If, in subsequent step 629, that deeper scan does not indicate the presence of such damage and/or excessive soil, the control system may next mark the tag and/or plate, dish or container itself (e.g., by burning it with a laser) to indicate that the plate, dish or container is ready for further processing (e.g., at a subsequent washer and/or drying station of the system for managing and processing reusable food containers, downstream from the pre-cleaning station), visually disambiguating the plate, dish or container from other objects, which the control system will discard, as discussed further below. The marked tag and/or plate will then be sent to such a subsequent washer and/or drying station of the system, in step 633, and the control system returns to the starting position.

If, however, at step 625, the control system determined that the tag does not indicate that the plate, dish or container detected matches an identified lot of soiled reusable plates, dishes or containers and/or belongs to a client of an owner of the control system, the control system may instead proceed to step 635, in which it marks the tag and/or plate, dish or container itself (e.g., by burning it with a laser) to indicate that the plate, dish or container is not to be processed, and must be discarded (e.g., at the next, downstream, separator station of the reusable dish and/or tray management and processor device, adjacent to the pre-cleaning station). To aid in managing the discarding of the so marked plate, dish or container, the control system may next rapidly take a reading of the speed of the upper surface of the conveyor belt, in step 637, and record a location and orientation of the so marked plate, dish or container on the upper surface, in step 639. From these data, in some embodiments, the control system may then calculate a projected arrival time and position and orientation of the so marked plate, dish or container at the separator station (or, at a separator device therein), in step 641. Furthermore, also based on these data, the control system may determine an action of a separator actuator (such as a separator arm or aimable compressed air jet) projected to collide with an exposed surface of the so marked plate, dish or container, and eject the so marked plate, dish or container laterally, e.g., in a direction 90 degrees from the direction of travel of the upper surface of the conveyor belt, in step 643, discarding the so marked plate, dish or container from the lot to be further processed (e.g., cleaned, dried, treated and packed for return to a customer within a single lot, as ordered). In some embodiments, if such a so marked plate, dish or container was among a group of plates, dishes or containers counted by the client and requested for such processing, the control system may “top off” the lot of processed plates, dishes or containers, with new containers of the same type supplied with appropriate new labeling, identifying the customer and lot, in step 645.

The control system may then return to the starting position.

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

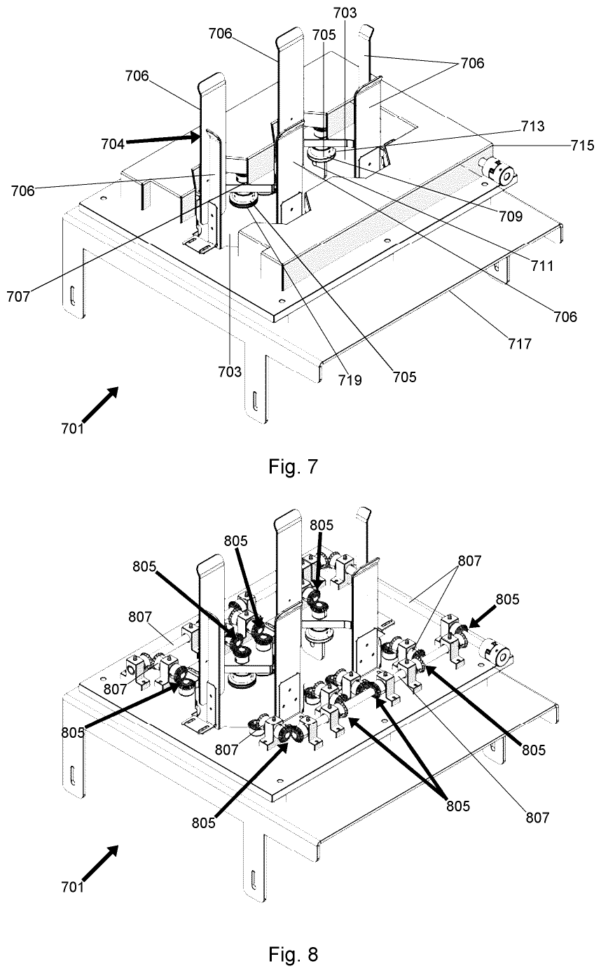

FIG. 7 is a three-quarter perspective drawing of an alternative embodiment of an example food container denester and dispenser 701, which may be similar to one of the denester and dispensers shown and discussed above, in accordance with some embodiments of the present application. More specifically, food container denester and dispenser 701 may be similar in nature to, the left-most (in the perspective of FIG. 1) of the example denester and dispensers 107 and example denester and dispenser 401, discussed above, except that its release port(s) 703 are differently shaped. Thus, other features of food container denester and dispenser 701, such as the nested tray stack holding and deployment feeder 704 including one or more stack-holding alignment guide(s) 706, may be similar in nature to features of other denesters and/or dispensers set forth above. Whereas release ports 405 of example denester and dispenser 401 were rectangular in profile, release ports 703 are octagonal in profile, having a shape complementary to, but slightly larger than, the shape of the perimeter of another, octagonally-shaped food container. But food container denester and dispenser 701 is otherwise similar in nature to example denester and dispenser 401, being configured to hold and dispense food containers of that shape.

As with example denester and dispenser 401, in some embodiments, as pictured, rotary release actuators, such as example rotary release actuators 705, are provided. As pictured, each of rotary release actuators 705 may rotate (e.g., by a rotary electric actuator, motor or servo-motor) about a central axel, such as the example central axel 707. In some embodiments, each of example rotary release actuators 705 includes an asymmetric lower flange, such as example asymmetric lower flange 709 (which are each generally, similar in shape to a cam) with one larger flange side 711 having a larger radius (measured from the center of central axel 712) than another, smaller flange side 713. In some such embodiments, when facing inward, toward the respective release port 405 which it borders, larger flange side 711 prevents the passage downward (e.g., with gravity) of a food container edge passing through that release port. In other words, when so facing inward, larger flange side 711 extends inward and beyond the width of that release port. Because each such rotary release actuator may rotate in unison, with each of their such larger flange sides facing inward simultaneously or outward simultaneously, e.g., by shared gearing (covered under example removable gear housing 715), and at a speed that may be controlled by the computer 111, example rotary release actuators 705 may rotate in a coordinated manner, to separate, denest and drop a single tray at a time.

As discussed elsewhere in this application, in some embodiments, local computer 111, or another PLC including or included within a control system, in accordance with some such embodiments, may include and/or be communicatively connected with one or more scanning apparatus(es) and/or sensor(s), including a sensor disposed on or about, or within line of site, of activity created by example food container denester and dispenser 701. In some embodiments, at least one such scanning apparatus or sensor may be disposed on or about a bottom 717 of denester and dispenser 701. In some embodiments, such a sensor may be, or may include, a motion sensor. In some embodiments, such a sensor may be, or may include, a camera. However, in some embodiments, such a sensor may be, or may include any other suitable sensor known in the art. In some such embodiments, such a motion sensor may be configured to sense motion of trays dropped or otherwise released through release ports 703. In some embodiments, such a sensor may detect the presence of a food container, such as a tray, on a conveyor, position(s) below, or approximately below, release ports 703. In some embodiments, such a sensor, in conjunction with object detection and orientation determining techniques, may determine whether food trays or other food containers have landed on such a conveyer in a planned or otherwise proper orientation (e.g., upright and/or with edges parallel to conveyer movement)—i.e., that the food containers have each been “properly dropped.” Thus, in some embodiments, such a computer and/or control system may determine whether trays or other food containers have been properly released or dropped. As discussed above, in some embodiments, such a computer and/or control system may halt the conveyer, and issue warning, alerts or other notices to users (e.g., through a speaker and/or display), if any such released or dropped containers are not properly dropped, as planned.

Although the example of release actuators with an asymmetric lower flange is provided, it will be understood by those of skill in the art that a wide variety of alternatives may be used, as an alternative, or in addition, to such release actuators. For example, in some embodiments, some or all of rotary release actuators 705 may include spiral threading 719, as pictured, which interfaces with and separates an individual edge of such an individual food trays.

Also, although the example of a food tray denester and dispenser has been provided, it should be understood that any suitable alternative form of nested food container, including addressable outer edges, may be similarly denested and dispensed, in a similar fashion, though release port(s) of a different shape and size, instead complementary to such an alternative form of nested food container, in various embodiments.

FIG. 8 is a three-quarter perspective drawing of an alternative embodiment of the example food container denester and dispenser 701, discussed immediately above, with rotary release actuator gearing, such as the example gearing 805, exposed and newly visible, in accordance with some embodiments, the example removable gear housing 715, discussed above, having been removed. In addition, example horizontally aligned cam shafts 807 are provided, translating and transmitting force from the gearing 805 to each of the plurality of rotary release actuators 705, linking the rotation of a plurality of rotary release actuators 705 at the same speed and alignment.

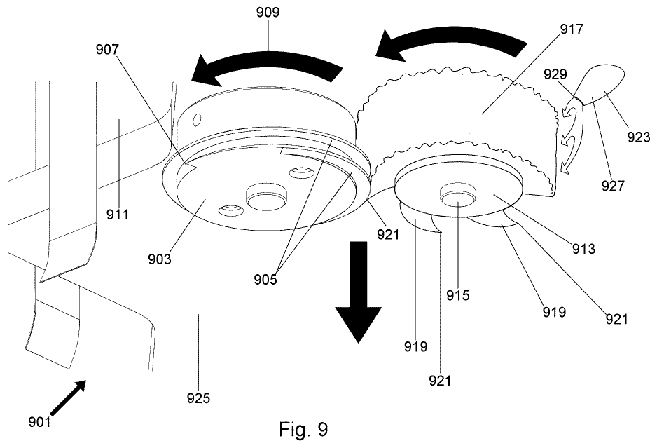

FIG. 9 is a perspective view, from the underside of an example embodiment of an example food container denester and dispenser 901, which may be the same as or similar to any of the example food container denesters/dispensers set forth in this application (such as example food container denester and dispenser 701), and including an example rotary release actuator 903. As with other example embodiments of denesters and dispensers set forth in the present application, example food container denester and dispenser 901 may include a plurality of rotary release actuators (e.g., 2, 3, 4, of more rotary release actuators, in various embodiments, 4 being preferred) which each may be similar in nature to example rotary release actuator 903, and may feature ancillary hardware similar to that shown in the present figure, and discussed below. However, to case comprehension, the present figure will illustrate such ancillary hardware with respect to the single example rotary release actuator pictured, namely, example rotary release actuator 903.

As with other example rotary release actuators set forth in the present application, in some embodiments, example rotary release actuator 903 includes example spiral threading 905, which engages a complementary, addressable outer edge of a food container to denest and dispense it from a nested stack of similar food containers. In more detail, in some embodiments, spiral threading 905 inserts, at a leading, tapered point and/or edge 907, in between such an addressable edge of such a lower-most nested food container and an addressable edge of a next-lower-most nested food container, above it, by rotating counterclockwise, in the perspective of the figure (as illustrated by example rotary motion arrow 909). As example rotary release actuator 903 continues to rotate counterclockwise, as illustrated, the width of the threading so inserted between the two containers edges increases from the tapered point and/or edge 907, until the pressure between the two containers exceeds any suction or other forces between the two, nested containers, and the lowermost container drops downward with gravity, denested.

As with other denesters and dispensers set forth in the present application, In some embodiments, such a stack of similar, nested food containers is initially held directly above one or more release port(s), such as example release port 911, through which such a denested lowermost food container may drop out of the denester and dispenser, and land in a receiving area (such as the upper surface of a conveyor, as in other embodiments set forth in the present application). In other words, as it is so separated, in some embodiments, such a lower-most nested food container will then be released from the remainder of the stack, through release port 911, and dispensed onto a conveyor, to be further processed in a different station or section of a system for handling and management of reusable food containers, as set forth in this application, while the remainder of the stack remains suspended above. In some such embodiments, after such a lower-most food container that has been so denested and dispensed is then carried away from denester and dispenser 901, rotary release actuator 903 completes a new rotation, and leading, tapered point or edge 907 again engages a new, lower-most nested food container in the stack (formerly, the second lower-most nested food), and repeats the same operation with respect to that new, lower-most nested food container, and so on, until each food container in the stack has been denested and dispensed, seriatim.

Although the example of a release actuator with spiral threading is provided herein, it will be understood by those of skill in the art that a wide variety of alternatives may be used, as an alternative, or in addition, to such release actuators. For example, in some embodiments, some or all of the rotary release actuators of denester and dispenser 901 may include another form of asymmetric flange, or a linear actuator, in some embodiments, which interfaces with and separates an individual edge of such an individual food trays.

Also, although the example of a generally rectilinear release port 911, and food tray denester and dispenser, have been provided, it should be understood that any suitable alternative form of nested food container, including addressable outer edges, may be similarly denested and dispensed, in a similar fashion, though release port(s) of a different shape and size, instead complementary to such an alternative form of nested food container, in various embodiments.

As discussed above, in some embodiments, such a stack of nested food containers are soiled, damaged and otherwise require cleaning, treatment and refurbishment, due to an earlier use cycle as a food container. And even if rinsed prior to being stacked and nested, in some embodiments, food particles, grease, broken pieces, and other matter may remain on the stacked food containers, even on or about the edges of the food containers. And, because the rotary release actuators of denester and dispenser 901 address and partially insert against and in between such addressable edges, they also may become soiled or even blocked from rotation and/or proper operation, by such accumulated matter. To manage and prevent such accumulated matter, in some embodiments, a new form of rotary actuator and brush and excavator tool 913 is provided, coupled with each such release actuator, and held against it as it rotates, in some such embodiments. In some such embodiments, as with rotary release actuators set forth in the present application, rotary actuator and brush and excavator tool 913 may itself be an actuator. For example, in some embodiments, rotary actuator and brush and excavator tool 913 is mounted on an axle 915, which may be connected to a rotary motor (not pictured). In a preferred embodiment, rotary actuator and brush and excavator tool 913 rotates counterclockwise, maximizing the moving, colliding interface between it and the rotary release actuator 903, due to the higher differential speed between the rotary actuator and brush and excavator tool 913 and the rotary release actuator 903 than would occur with counter-rotation. In some embodiments, rotary actuator and brush and excavator tool 913 includes multiple subtools. For example, in some embodiments, rotary actuator and brush and excavator tool 913 includes one or more brush portion(s) 917 and one or more scraper portion(s) 919. In some embodiments, such a brush portion may include any material and structure known in the art for cleaning brushes. In some embodiments, a wire brush material and structure is used, and preferred, and a metal wire brush material and structure is even more greatly preferred within brush portion(s) 917. However, in some embodiments, a spongy or nappy material may be used, instead of or in addition to such materials, within brush portion(s) 917. And, in some embodiments, such a scraper portion may include any material and structure known in the art for picking, chipping and wiping away surface materials from surfaces. In some embodiments, a rubber or plastic material including a series of periodic blades and/or other edges 921 is included within scraper portion(s) 919.

In some embodiments, a high-velocity pressure washer 923 is provided, e.g., also mounted on the underside 925 of example food container denester and dispenser 901. In some embodiments, high-velocity pressure washer 923 is aimed at and periodically sprays rotary actuator and brush and excavator tool 913, clearing it of debris. In some embodiments, a pump and/or steam pressure generator provides air, water and/or other fluids to a nozzle 927, which narrows toward an exit port 929, of high-velocity pressure washer 923, channeling such fluids on or about a portion of the rotary actuator and brush and excavator tool 913 facing it. In some embodiments, high-velocity pressure washer 923 is configured to selectively release such fluids, at timed intervals and durations, in accordance with commands from a control system with which it is connected. And because, in some embodiments, a sensor is provided on the underside 925 (or, in some embodiments, a rotational position sensor is provided) which may aid the control system in determining the rotational position of rotary actuator and brush and excavator tool 913, the control system can command high-velocity pressure washer 923 to selectively pressure-wash different portions and sub-tools of the rotary actuator and brush and excavator tool 913. For example, in some embodiments, the control system causes the high-velocity pressure washer 923 to apply more fluids and pressure and spend more time applying fluids and pressure, to one of the sub-tools, or a portion thereof. For example, in some such embodiments, the control system causes the high-velocity pressure washer 923 to apply more fluids and pressure, and/or spend more time applying fluids and pressure, to the brush portion(s) 917.

What is claimed is:

1. A system for managing and processing reusable food containers, comprising:
a control system comprising specialized computer hardware and software, wherein said computer hardware comprises a PLC;
a structural base;
a receiving end;
one or more tray denester(s)/dispenser(s);
a tray conveyor;
at least one scanning device provided at or about a pre-cleaning station of said system for managing and processing reusable food containers;
at least one separator; and
a second, offloading end.

2. The system for managing and processing reusable food containers of claim 1, wherein said separator comprises an actuator comprising an air compressor and a compressed air tank.

3. The system for managing and processing reusable food containers of claim 1, wherein said separator comprises an actuator comprising a sweeping arm.

4. The system for managing and processing reusable food containers of claim 1, wherein a bin with an open top and/or bottom, configured to catch discarded food containers, is attached to a side of said system, abutting and parallel to said conveyor at or about a location of said separator.

5. The system for managing and processing reusable food containers of claim 1, wherein said scanning device comprises a scanner and/or a camera, and wherein said scanner and/or camera is configured to identify a type of reusable food containers that a reusable food container being conveyed through said pre-cleaning station is.

6. The system for managing and processing reusable food containers of claim 5, wherein said control system causes said scanner and/or a camera to perform a focused scan of an encoded, data-bearing tag, and wherein said scanner and/or camera is configured to aid the control system in identifying a type of reusable food containers that a reusable food container being conveyed through said pre-cleaning station is.

7. The system for managing and processing reusable food containers of claim 5, wherein said control system causes said scanner and/or a camera to perform a focused scan of an encoded, data-bearing tag, and wherein said scanner and/or camera is configured to aid the control system in identifying a lot of soled reusable food containers, and/or client of an owner of the control system, to which a reusable food container being conveyed through said pre-cleaning station belongs.

8. The system for managing and processing reusable food containers of claim 7, wherein the control system determines whether the encoded, data-bearing tag indicates that the reusable food container being conveyed through said pre-cleaning station matches an identified lot of soiled reusable food containers and/or belongs to a client of an owner of the control system.

9. The system for managing and processing reusable food containers of claim 8, wherein the control system individually identifies the reusable food container being conveyed through said pre-cleaning station, and projects an arrival time, of the reusable food container being conveyed through said pre-cleaning station, at a different part of the system for managing and processing reusable food containers downstream from the pre-cleaning station.

10. The system for managing and processing reusable food containers of claim 9, wherein the control system records a position and orientation of said reusable food container being conveyed through said pre-cleaning station, and determines an action to be carried out at said separator based on said position and orientation.

11. The system for managing and processing reusable food containers of claim 1, wherein said separator is configured to remove food particles or other soil, based at least in part on imaging by at least one of said plurality of scanning devices.

12. The system for managing and processing reusable food containers of claim 1, wherein at least one of said scanning device(s) and said control system are configured to determine if a tag attached to each of said reusable food containers indicates a number of wash and/or use cycles exceeding a pre-set number of wash and/or use cycles.

13. The system for managing and processing reusable food containers of claim 12, wherein said control system is configured to remove a reusable food container, using said separator, if a tag attached to the reusable food container indicates a number of wash and/or use cycles for the reusable food container exceeding said pre-set number of wash and/or use cycles.

14. The system for managing and processing reusable food containers of claim 12, wherein said control system is configured to remove a reusable food container, using said separator, if said control system determines that an amount of soil exceeds a predetermined threshold for reusable food containers of said type of reusable food containers.

15. The system for managing and processing reusable food containers of claim 1, wherein said conveyor comprises a conveyor belt, comprising:
a food container conveying outer surface, comprising:
an upward-facing portion; and
a downward-facing portion; and
at least one rotary release actuator, coupled with a rotary brush and/or pick, wherein said rotary brush and/or pick is driven to corotate with said rotary release actuator.

16. The system for managing and processing reusable food containers of claim 15, comprising a high-velocity pressure washer, wherein said high-velocity pressure washer is attached on or about an underside of a base of the system for managing and processing reusable food containers, and wherein the high-velocity pressure washer is aimed at said downward-facing portion of said food container conveying outer surface of said conveyor belt and/or a brush wheel mounted on or about said.

17. The system for managing and processing reusable food containers of claim 1, comprising at least one lower shelf and at least one sink, provided below said underside of said base of the system for managing and processing reusable food containers.

18. The system for managing and processing reusable food containers of claim 16, comprising at least one lower shelf comprising at least one sink, provided below said underside of said base of the system for managing and processing reusable food containers, and further provided at least partially directly below said downward-facing portion of said food container conveying outer surface of said conveyor belt.

19. A method for managing and processing reusable food containers, comprising the following steps:
providing a system for managing and processing reusable food containers, comprising:
a control system comprising specialized computer hardware and software,
wherein said computer hardware comprises a PLC;
a structural base;
a receiving end;
one or more tray denester(s)/dispenser(s);
a tray conveyor;
at least one scanning device provided at or about a pre-cleaning station of said system for managing and processing reusable food containers;
at least one separator; and
a second, offloading end.
